(19) United States
(12) Patent Application Publication
(10) Pub. No.: US 2006/0256123 A1
(43) Pub. Date: Nov. 16, 2006

(54) Generation of attribute pattern image by patterning attribute information

(76) Inventor: Noriko Miyagi, Kanagawa (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/433,841

(22) Filed: May 12, 2006

(30) Foreign Application Priority Data
May 12, 2005 (JP) 2005-140426

(51) Int. Cl. G09G 5/00

(52) U.S. Cl. 345/581

(57) ABSTRACT

An image processing apparatus includes an image acquisition unit to acquire an image, an attribute determining unit to determine position-dependent attributes of the acquired image acquired by the image acquisition unit, and a patterning unit to generate an attribute pattern image that represents the position-dependent attributes by respective spatial patterns.

### PRIORITY

The present application claims priority to and incorporates by reference the entire contents of Japanese priority document 2005-140426, filed in Japan on May 12, 2005.

### BACKGROUND OF THE INVENTION

1. Field of the Invention

The present invention generally relates to image processing apparatuses, image processing methods, and computer-readable recording media, and particularly relates to an image processing apparatus, an image processing method, and a computer-readable recording medium by which image processing is performed responsive to the attributes of an image.

2. Description of the Related Art

Most color copiers have a function to determine image attributes such as a black-letter area, a color-letter area, and a screen-dot area in documents scanned by the scanner and to perform various image processing operations such as a filtering process and a black generation responsive to the determined attributes. This function is useful as it makes it possible to produce high-quality output images even when the original documents are a mixture of various types of images.

In the case of color images, there is a strong demand for the high-quality reproduction of a black-letter portion, so that it is dispensable to reproduce a K-monochrome image for the black-letter portion identified by the above-described function. This is because, while the reproduction of black letters by use of CMYK may cause noticeable image-quality degradation due to coloring around the black letters in the case of displacement of color images at the time of producing a printout, the reproduction by use of monochrome K is not affected by such displacement of color images at the time of producing a printout.

Due to recent improvements in the speed of networks, it has become possible to connect a desired number of color scanners and a desired number of color printers in a flexible manner via a network. As a system that provides a network-color copier by connecting a color scanner and a color printer via a network, Japanese Patent Application Publication No. 2004-289589 discloses an apparatus to which a plurality of scanners and a plurality of printers are connected via a network as shown in FIG. 2.

A four-fold tandem-drum system that completes the scanning of the four broken-down color components M, C, Y, and K at a single step has been brought to fruition in response to the demand for a faster color printing system. Such a system, however, requires a large-capacity image memory for storing the signals representing the four colors, resulting in a need for the reduction of memory capacity. In consideration of this, Japanese Patent Application Publication No. 8-98030 discloses an apparatus and method for lowering the resolution of attribute information for the purpose of reducing the amount of information to be stored in memory. This document provides a method of compressing the attribute information for controlling the under color removal process, for example, into the information that is provided separately for each 4-pixel-by-4-pixel unit area, thereby reducing the amount of attribute information.

The technologies described above have problems as follows.

The apparatus of Japanese Patent Application Publication No. 2004-289589 transmits to an external printer the information indicative of the results of the check to determine black letters together with the irreversible compressed image. Unlike the transmission of only the results of the check to determine black letters, an additional transmission of the results of the checks to determine color letters and screen dots together with the compressed image results in an increase in the amount of transmitted information due to the transmission of attached attribute information. This is problematic because of the heavy load imposed on the network.

Japanese Patent Application Publication No. 8-98030 provides a method of compressing the attribute information into the information that is provided separately for each 4-pixel-by-4-pixel unit area. With this provision, however, if the attribute information with the reduced resolution is transmitted to an exterior, image degradation may occur when the recipient printer performs an under color removal process, for example. In the following, image degradation will be described.

FIGS. 3A through 3C are drawings showing an original image of a portion of a black letter, the results of the check to determine a black letter, and the check results converted into larger blocks on a 2×1-pixel basis, respectively.

FIGS. 4A and 4B are drawings each showing an image obtained by reproducing a portion with the black-letter attribute information by use of monochrome K and reproducing an interior portion with the non-black-letter attribute information by use of CMY after the black generation and under color removal are performed based on the attribute information as shown in FIGS. 3B and 3C.

If the K monochrome reproduction and the CMY reproduction do not coincide in terms of color reproduction, the reproduction made by use of FIG. 3C may produce color or density discontinuity having a larger stepwise shape inside the letter. Even if the color reproduction is consistent, the displacement of color images at the time of producing a printout creates white voids in large stepwise arrangement appearing inside the letter as shown in FIG. 4B. White voids also appear in FIG. 4A, but the oddity is less conspicuous as the white voids are arranged in a straight line. In the case of FIG. 4B, the 2-dot white voids are arranged at constant intervals without forming a straight line, thereby creating more conspicuous image degradation.

Examples of image degradations other than those described above include a degradation caused by treating a color-letter portion with the process for a black-letter portion when the area having the black-letter attribute information is expanded in an image having a mixture of black letters and color letters.

In this manner, the larger the size of unit blocks, the greater the degradation of the image is.

Accordingly, there is a need for a scheme for the transmission or storage of attribute information that can reduce the amount of transmitted or stored information without reducing the resolution of the letter attribute information, especially the resolution of the black-letter attribute information.

### SUMMARY OF THE INVENTION

A generation of attribute pattern image by patterning attribute information is described. In one embodiment, an image processing apparatus comprises an image acquisition unit to acquire an image, an attribute determining unit to determine position-dependent attributes of the acquired image acquired by the image acquisition unit, and a patterning unit to generate an attribute pattern image that represents the position-dependent attributes by respective spatial patterns.

### BRIEF DESCRIPTION OF THE DRAWINGS

Other embodiments and further features of the present invention will be apparent from the following detailed description when read in conjunction with the accompanying drawings, in which:

FIG. 1 is a block diagram of an image processing apparatus according to a first embodiment of the present embodiment;

FIG. 2 is a drawing showing a plurality of scanners and a plurality of printers connected to a network;

FIGS. 3A through 3C are drawing showing an original image of a portion of a black letter, the results of the check to determine a black letter, and the check results converted into larger blocks on a 2×1-pixel basis, respectively;

FIGS. 4A and 4B are drawings each showing an image obtained by reproducing a portion with the black-letter attribute information by use of monochrome K and reproducing an interior portion with the non-black-letter attribute information by use of CMY after the black generation and under color removal are performed based on the attribute information as shown in FIGS. 3B and 3C;

FIG. 5 is a block diagram showing the attribute determining unit 15;

FIG. 6 is a drawing showing the assignment of attribute information to two bit signals;

FIG. 7 is a block diagram showing the edge determining unit;

FIG. 8 is a drawing showing patterns used by a black-pixel pattern matching unit;

FIG. 9 is a drawing showing patterns used by a white-pixel pattern matching unit;

FIG. 10 is a block diagram showing the white-background determining unit;

FIG. 11 is a drawing showing patterns used by a pattern matching unit;

FIG. 12 is a block diagram showing the screen-dot determining unit;

FIGS. 13A and 13B are drawings for illustrating the operations performed by peak pixel detecting units;

FIG. 14 is a block diagram showing the color check unit;

FIGS. 15A through 15D are drawings showing patterns of an attribute pattern image;

FIGS. 16A through 16C are illustrative drawings showing a portion of a black letter image, the results of attribute determination, and the patterned results of attribute determination, respectively;

FIGS. 17A through 17C are illustrative drawings showing a portion of a color letter image, the results of attribute determination, and the patterned results of attribute determination, respectively;

FIGS. 18A through 18C are illustrative drawings showing a portion of a screen-dot image, the results of attribute determination, and the patterned results of attribute determination, respectively;

FIG. 19 is a block diagram of an image processing apparatus according to a second embodiment of the present embodiment;

FIG. 20 is a block diagram of an image processing apparatus according to a third embodiment of the present embodiment;

FIG. 21 is a block diagram showing the edge-amount detecting unit;

FIGS. 22A through 22D are drawings showing the filter coefficients of first through fourth edge-amount detecting filters, respectively;

FIG. 23 is a block diagram showing the pattern analyzing unit;

FIGS. 24A through 24D are drawings showing patterns used in pattern matching performed by the black-letter pattern detecting unit;

FIG. 25 is a drawing showing line memories required in the processing blocks enclosed by dotted lines in FIG. 20;

FIG. 26 is a block diagram of an image processing apparatus according to a fourth embodiment of the present embodiment;

FIG. 27 is a block diagram of an image processing apparatus according to a fifth embodiment of the present embodiment;

FIG. 28 is a drawing showing the assignment of object attributes to three bit signals; and

FIGS. 29A and 29B are drawings showing patterns of an attribute pattern image.

### DESCRIPTION OF THE PREFERRED EMBODIMENTS

One or more embodiments of the present invention include an image processing apparatus and an image processing method that substantially obviate one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Embodiments as well as other features and advantages of the present invention will be realized and attained by an image processing apparatus and an image processing method particularly pointed out in the specification in such full, clear, concise, and exact terms as to enable a person having ordinary skill in the art to practice the invention.

To achieve these and other advantages in accordance with the purpose of the invention, an embodiment of the invention includes an image processing apparatus which includes an image acquisition unit to acquire an image, an attribute determining unit to determine position-dependent attributes of the acquired image acquired by the image acquisition unit, and a patterning unit to generate an attribute pattern image that represents the position-dependent attributes by respective spatial patterns.

According to another embodiment of the present invention, an image processing apparatus includes an image acquisition unit to acquire an image comprised of a plurality of embodiments, an expanding unit to expand the embodiments into a bitmap image, a generating unit to generate an attribute pattern image that represents portions of the bitmap image by respective spatial patterns responsive to attributes of the embodiments, a storage unit to store the acquired image and the attribute pattern image, and an image processing unit to retrieve the acquired image and the attribute pattern image from the storage unit to perform image processing with respect to the acquired image according to the position-dependent attributes.

According to yet another embodiment of the present invention, a method of processing an image includes acquiring an image, determining position-dependent attributes of the acquired image, and generating an attribute pattern image that represents the position-dependent attributes by respective spatial patterns.

According to still yet another embodiment of the present invention, a computer-readable recording medium having a program embodied therein for causing a computer to process an image by acquiring an image, determining position-dependent attributes of the acquired image acquired, and a patterning step of generating an attribute pattern image that represents the position-dependent attributes by respective spatial patterns.

According to at least one embodiment of the present invention, it is possible to perform image processing without substantially lowering the resolution of attribute information while suppressing the amount of data. In the case of an apparatus for transmitting attribute information to an external apparatus, the amount of transmitted information can be reduced without lowering the resolution of the letter attribute information, especially the resolution of the black-letter attribute information. In the case of an apparatus that does not transmit attribute information to an external apparatus, the amount of data internally transmitted or stored for an internal process can be reduced.

In the following, embodiments of the present invention will be described with reference to the accompanying drawings.

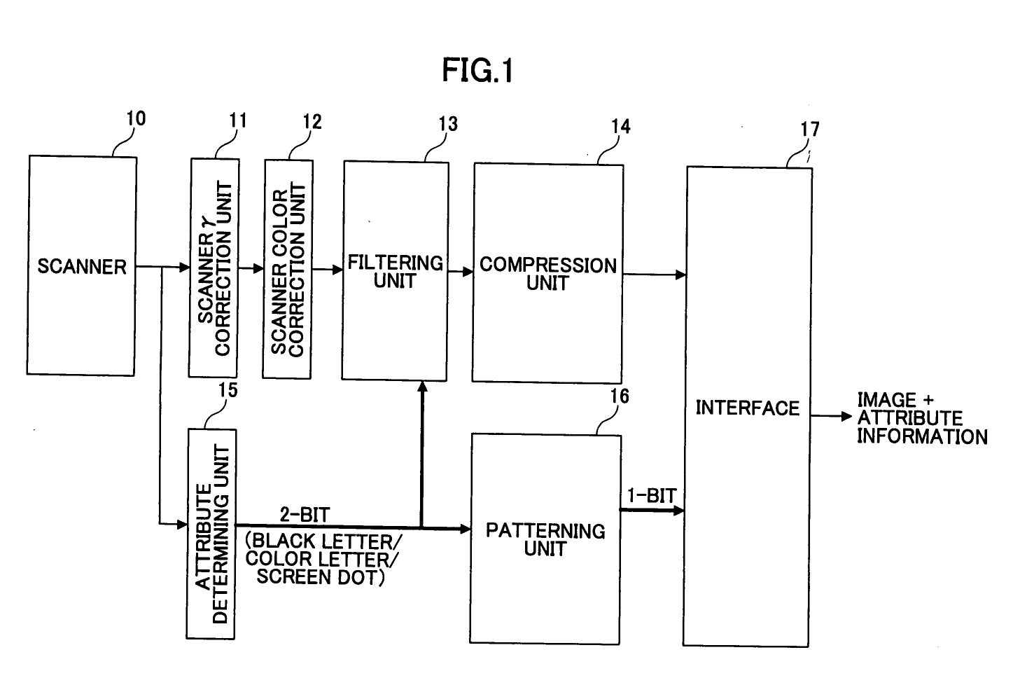

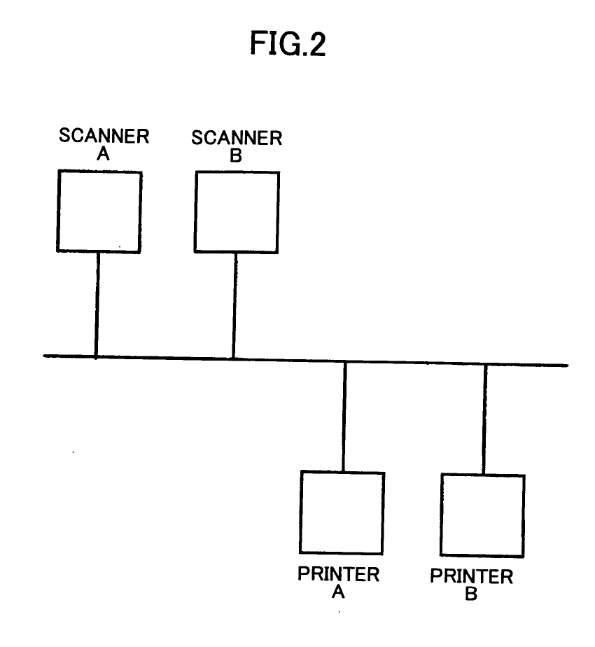

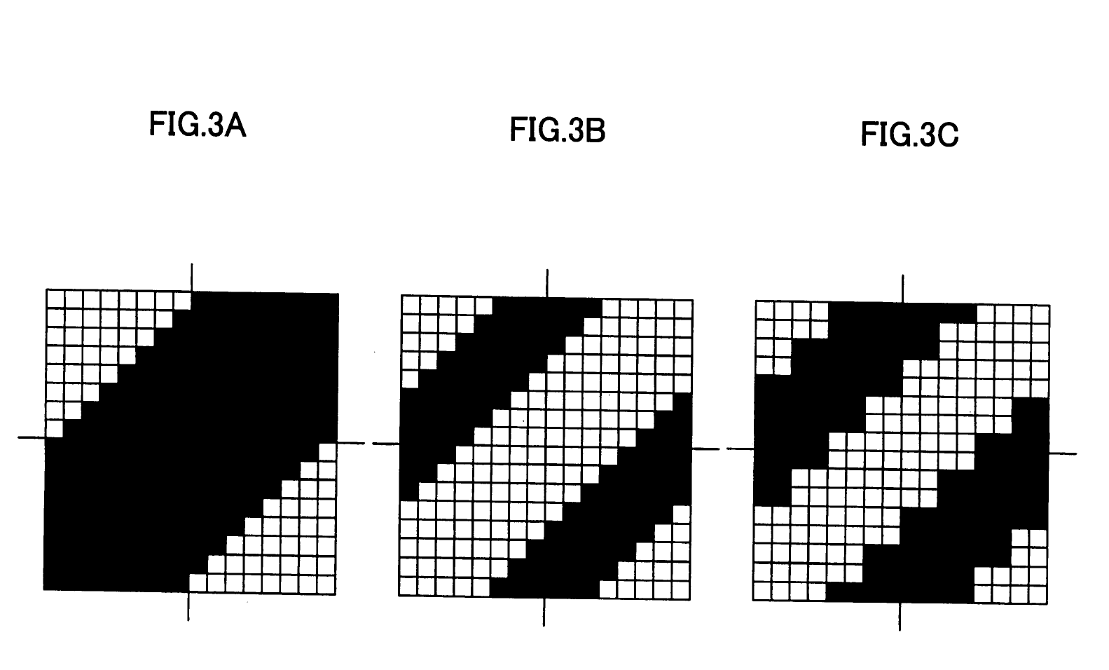

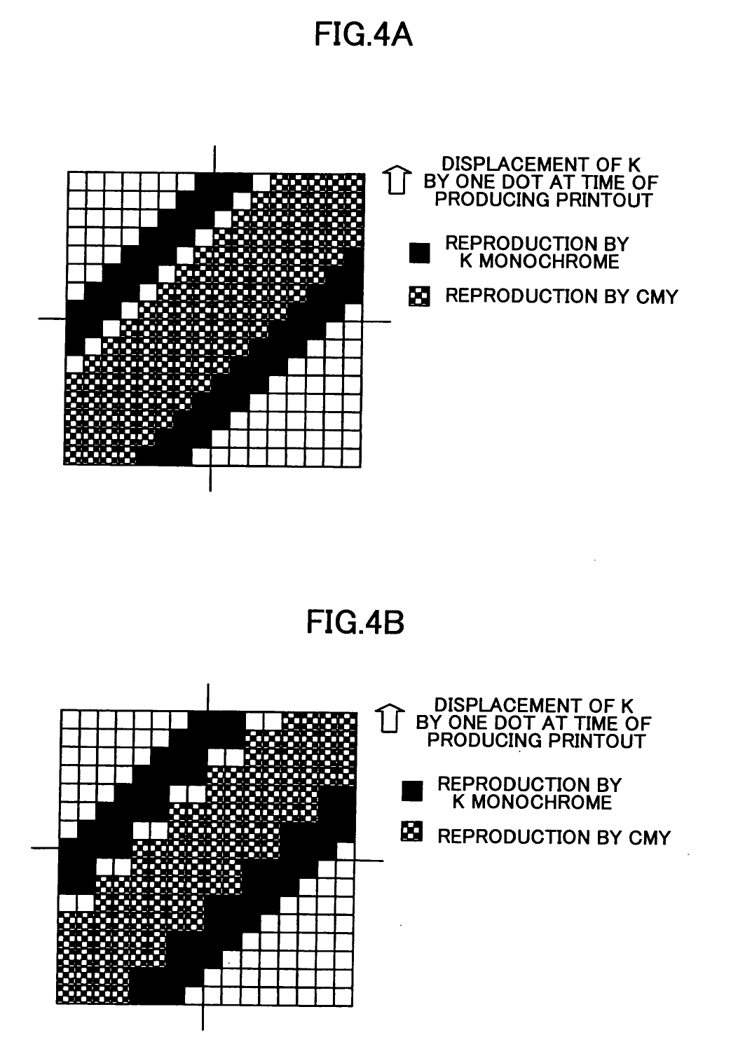

FIG. 1 is a block diagram of an image processing apparatus according to a first embodiment of the present embodiment. The image processing apparatus of FIG. 1 includes a scanner 10 for scanning a document image, a scanner γ correction unit 11 for performing various image processing operations, a scanner color correction unit 12, a filtering unit 13, a compression unit 14 for compressing the filtered image, an attribute determining unit 15 for determining the attributes of the scanned input image, a patterning unit 16 for converting the attribute information into an attribute pattern image, and an interface 17 for transmitting the image and the attribute information to an external apparatus.

In the following, a description will be given of the outline of the image processing apparatus shown in FIG. 1. The scanner 10 scans a document to acquire color image signals comprised of RGB, to which various image processing operations are performed by the scanner γ correction unit 11, the scanner color correction unit 12, and the filtering unit 13. The scanner γ correction unit 11 performs a process that corrects the γ characteristics of the scanner by use of one-dimensional LUT (lookup table) conversion. The scanner color correction unit 12 performs a process that coverts device-dependent RGB signals into device-independent signals.

In this example, sRGB signals are converted into luminance and chrominance signals sYCbCr by use of 3×3 matrix. The filtering unit 13 performs smoothing and edge enhancement. The attribute determining unit 15 determines the attributes of the scanned input image to produce attribute information indicative of black letters, color letters, or screen dots. The filtering unit 13 refers to such attribute information to perform respectively suitable filtering processes. As for black letters, almost no smoothing is performed, and edge enhancement is performed with respect to luminance signal Y. As for color letters, almost no smoothing is performed, and edge enhancement is performed with respect to chrominance signals CbCr. As for screen dots, strong smoothing is applied, with little enchancement. The compression unit 14 applies JPEG or the like to compress the image processed by the filtering unit 13. Further, the patterning unit 16 converts the attribute information indicative of black letters, color letters, and screen dots into an attribute pattern image comprised of 1 bit per 1 pixel. The compressed image and the attribute pattern image are combined to be transmitted to an external apparatus via the interface 17.

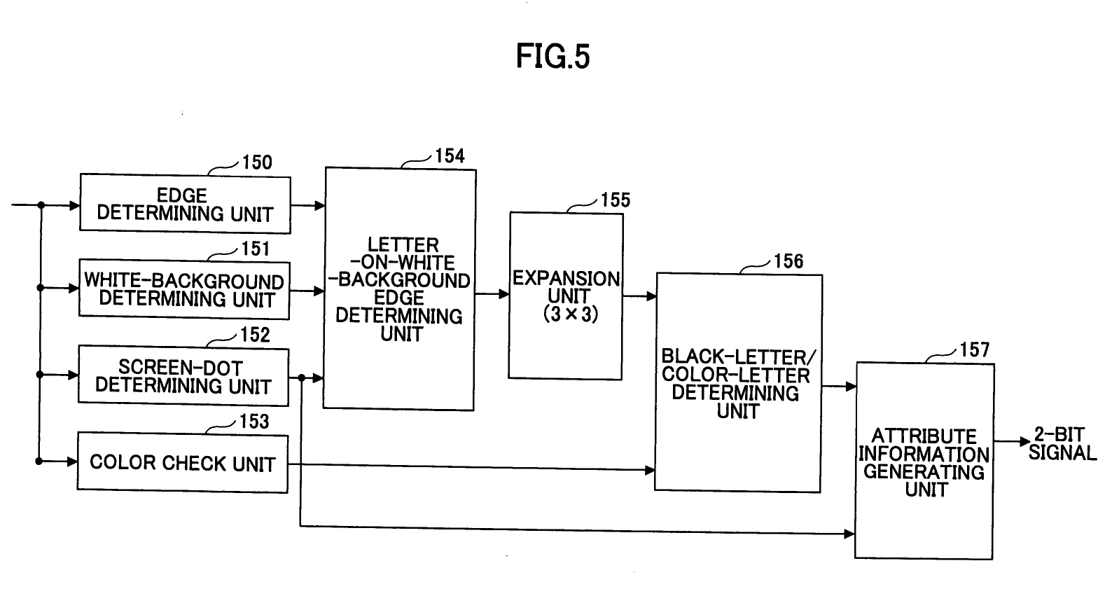

FIG. 5 is a block diagram showing the attribute determining unit 15. The attribute determining unit 15 includes an edge determining unit 150 for determining edge portions of letters and line drawings, a white-background determining unit 151 for determining a white background, a screen-dot determining unit 152 for discriminating picture portions drawn by use of screen dots, a color check unit 153 for checking chromatic color portions, a letter-on-white-background edge determining unit 154 for determining letter edge candidate pixels if certain conditions are met, an expansion unit 155 for treating a pixel of interest as a letter edge if certain conditions are met, a black-letter/color-letter determining unit 156 for determining black letters and color letters, and an attribute information generating unit 157 for generating attribute information images based on the check results produced by the black-letter/color-letter determining unit 156 and the screen-dot determining unit 152.

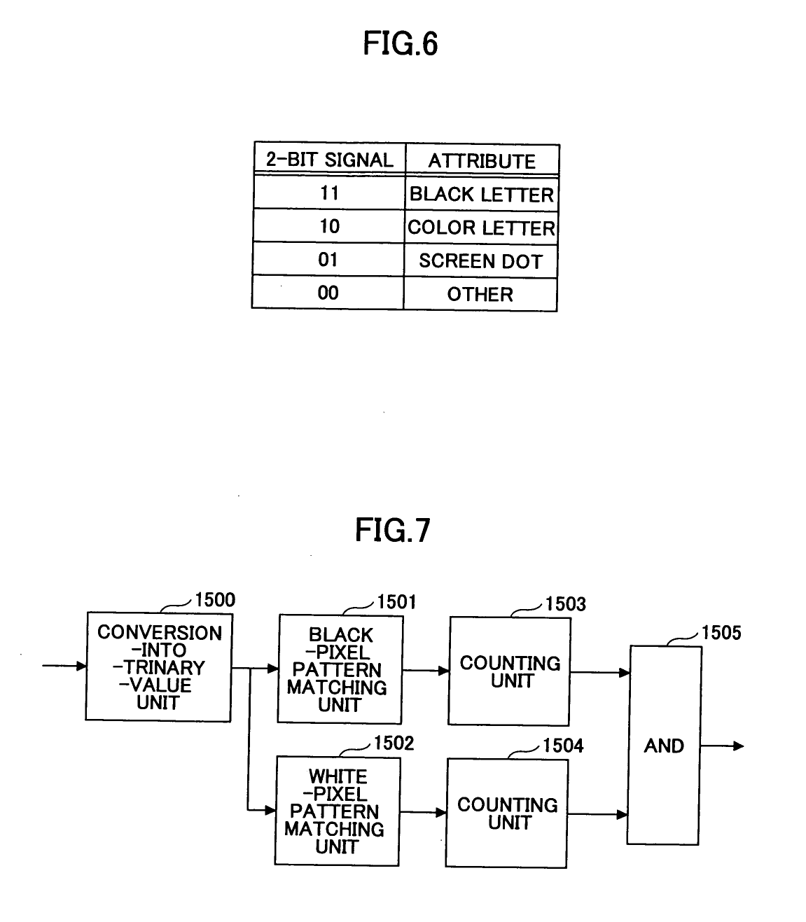

Based on the results obtained by the edge determining unit 150, the white-background determining unit 151, and the screen-dot determining unit 152, the letter-on-white-background edge determining unit 154 determines letter edge candidate pixels. If both an edge and a white background are detected, and if no screen dot is detected, the pixel is determined to be a letter edge candidate pixel. The letter edge candidate pixel is not limited to the pixel of this condition. When the edge determining unit 150 is used, as will later be described, one dot is detected as a letter edge candidate pixel separately for each of an interior edge residing inside a letter or a drawn line and an exterior edge residing outside the letter or the drawn line. A total of two dots, i.e., one interior dot and one exterior dot, are not sufficient for the process to be performed by the filtering unit 13, so that the expansion unit 155 performs a 3-×-3 expansion process, the result of which is then treated as a “letter edge”. The expansion unit 155 refers to the pixels of the 3-pixel-by-3-pixel area centered at a pixel of interest, and designates the pixel of interest as a letter edge if any one of these pixels is a letter edge candidate pixel. In this example, a 3-×-3 expansion is performed. Alternatively, a 5-×-5 expansion or the like may be performed by taking into account the color displacement characteristics of the scanner and the amount of expansion that is necessary for the filtering process. The black-letter/color-letter determining unit 156 selects “color letter” if the results of the letter edge and the color check unit 153 indicate a letter edge and a chromatic color, and selects “black letter” if the results of the letter edge and the color check unit 153 indicate a letter edge and an achromatic color. The attribute information generating unit 157 generates a 2-bit attribute information image based on the screen-dot signal obtained by the screen-dot determining unit 152 used in the filtering process in addition to “black letter” and “color letter”. The assignment of each attribute to the two bit signal is shown in FIG. 6. If a given pixel is determined as “black letter”, for example, the attribute information “11” is assigned to this pixel.

FIG. 7 is a block diagram showing the edge determining unit 150. The edge determining unit 150 includes a conversion-into-trinary-value unit 1500 for converting the G signal among the input signals into a trinary-value signal, a black-pixel pattern matching unit 1501 for determining whether a pixel of interest is one of contiguous black pixels, a white-pixel pattern matching unit 1502 for determining whether a pixel of interest is one of contiguous white pixels, a counting unit 1503 for counting the number of continuous black pixels, a counting unit 1504 for counting the number of continuous white pixels, and an AND gate 1505 for determining an edge portion if certain conditions are satisfied.

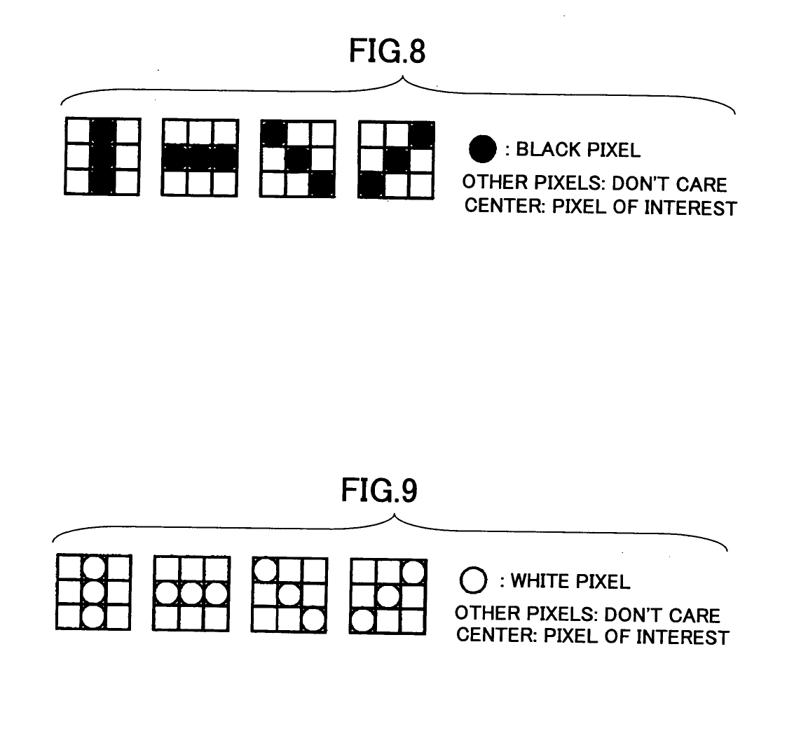

The conversion-into-trinary-value unit 1500 converts the G signal among the RGB input images each comprised of 8 bits into a trinary value by use of two thresholds th1 and th2 (th1<th2). The value “0” corresponds to the shadow side, and the value “255” corresponds to the highlight side. If 0≦G≦th1, the pixel of interest is assigned as a black pixel. If th1<G<th2, the pixel of interest is assigned as a medium pixel. If th2≦G≦255, the pixel of interest is assigned as a white pixel. The black-pixel pattern matching unit 1501 determines that the pixel of interest is one of continuous black pixels if the 3-×-3 matrix has a black pixel pattern that matches any one of the patterns shown in FIG. 8. By the same token, the white-pixel pattern matching unit 1502 determines that the pixel of interest is one of contiguous white pixels if the white pixel pattern matches any one of the patterns shown in FIG. 9. Thereafter, the counting unit 1503 and the counting unit 1504 count the number of contiguous black pixels and the number of contiguous white pixels, respectively, in the 3-×-3 pixel area centered at the pixel of interest. If the count is more than a predetermined value (e.g., 2), “1” is output. The AND gate 1505 determines that the pixel of interest is an edge portion if both of the two counts indicate “1”. Namely, this determination is made by utilizing the fact that contiguous white pixels and contiguous black pixels tend to coexist with more than a predetermined density at the contour portion of letters.

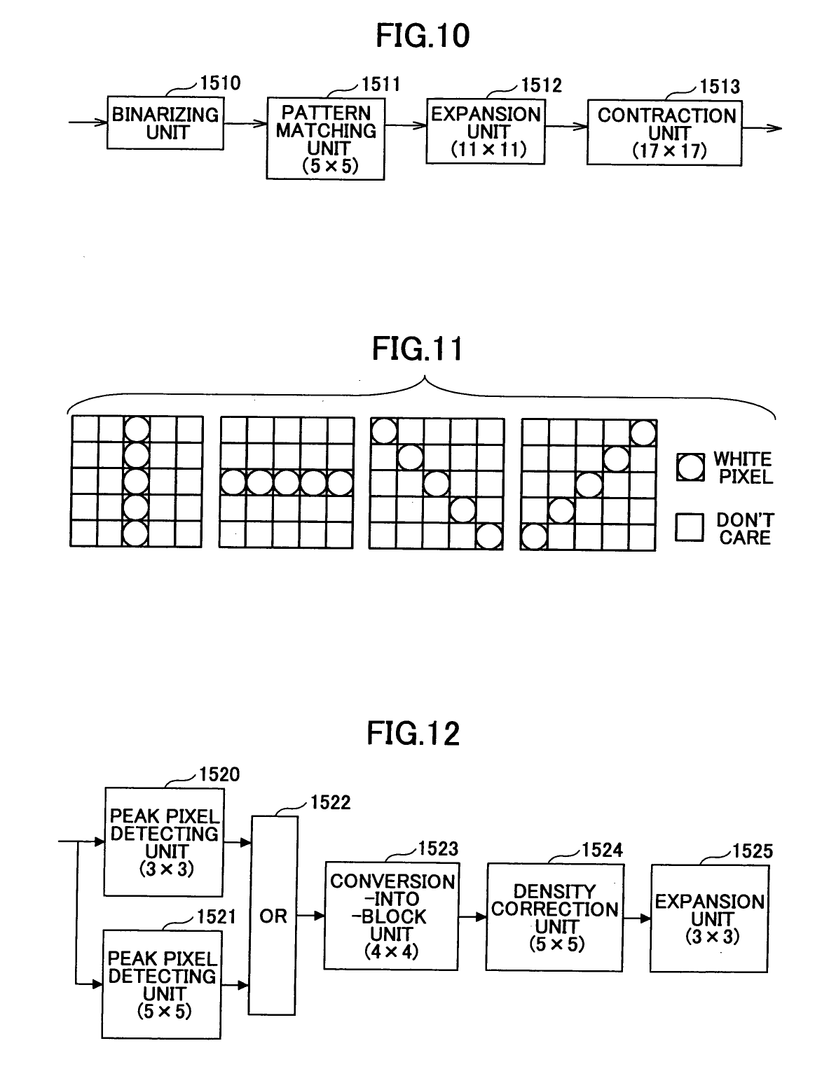

FIG. 10 is a block diagram showing the white-background determining unit 151. The white-background determining unit 151 includes a binarizing unit 1510 for binarizing the G signal among the input signals, a pattern matching unit 1511 for performing a pattern matching with respect to white pixels and black pixels, an expansion (11×11) unit 1512 for converting the pixel of interest into a white pixel, and a contraction (17×17) unit 1513 for converting the pixel of interest into a black pixel.

The binarizing unit 1510 makes a binary decision by determining whether the pixel of interest of the G signal is a white pixel or black pixel. The pattern matching unit 1511 performs a pattern matching (5×5) with respect to the determined white pixels, thereby reversing the decision made for an isolated white pixel. Specifically, the pattern matching that finds a continuity of white pixels in the four directions including a vertical direction, a horizontal direction, and two diagonal directions as shown in FIG. 11 is performed. If there is a match, a white pixel is assigned. If no match is found, a black pixel is assigned. Then, the expansion unit 1512 refers to 11-×-11 surrounding pixels inclusive of the pixel of interest, and converts the pixel of interest into a white pixel if any one of these pixels is a white pixel. Thereafter, the contraction unit 1513 refers to 17-×-17 surrounding pixels inclusive of the pixel of interest, and converts the pixel of interest into a black pixel if any one of these pixels is a black pixel. An area that remains as white pixels after the contraction process is an area that is determined as a white-background area in the end.

FIG. 12 is a block diagram showing the screen-dot determining unit 152. The screen-dot determining unit 152 includes a peak pixel detecting unit 1520 for detecting a peak pixel by use of condition (1), a peak pixel detecting unit 1521 for detecting a peak pixel by use of condition (2), an OR gate 1522 for determining a peak pixel if certain conditions are satisfied, a conversion-into-block unit 1523 for determining an active block if certain conditions are met, a density correction unit 1524 for designating the pixel of interest as a screen-dot block if certain conditions are met, and an expansion unit 1525 for performing an expansion process using a 3-×-3 block.

The screen-dot determining unit 152 makes a screen dot determination by use of a peak pixel detecting method. The detection of a peak pixel is performed by determining whether the pixel of interest is a local minimum or a local maximum in terms of gray scale changes based on the relationship with the gray scales of the surrounding pixels. If the gray scale level of the center pixel is the highest or lowest in the M-pixel-by-M-pixel blocks, a decision as to whether this pixel is a local maximum/minimum is made by use of the condition (1) or (2). The peak pixel detecting unit 1520 detects a peak pixel by use of the condition (1), and the peak pixel detecting unit 1521 detects a peak pixel by use of the condition (2).

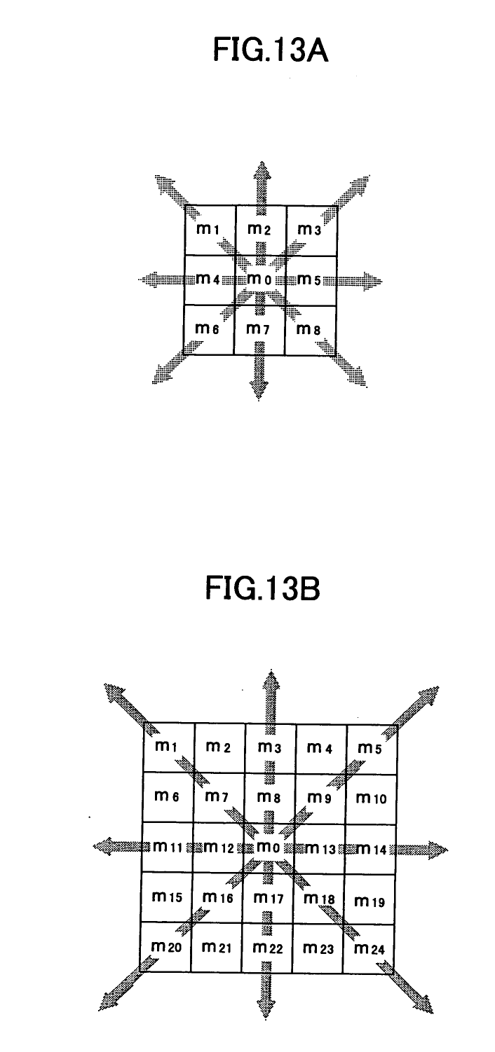

Condition (1): M=3 (FIG. 13A)
|2m0−m1−m8|≧ΔmTH; and
|2m0−m2−m7|≧ΔmTH; and
|2m0−m3−m6|≧ΔmTH; and
|2m0−m4−m5|≧ΔmTH.
Condition (2): M=5 (FIG. 13B)
|2m0−m3−m22|≧ΔmTH; and
|2m0−m8−m17|≧ΔmTH; and
|2m0−m1−m24|≧ΔmTH; and
|2m0−m7−m18|≧ΔmTH.
Namely, if the absolute value of the difference in gray scales between the center pixel and the average of two pixels deposited at symmetrical positions across the center pixel is larger than the threshold value (mTH, this center pixel is detected as a peak). The peak pixel detection may be performed with respect to each of the RGB signals. Alternatively, the peak pixel detection may be performed only with respect to the G signal in a simplified case. A decision as to whether or not the area of interest is a screen-dot area is then made based on information relating to the peak pixel. The OR gate 1522 detects a peak pixel if at least one of the peak pixel detecting unit 1520 and the peak pixel detecting unit 1521 detects a peak pixel. Thereafter, with respect to each 4-pixel-by-4-pixel block, the conversion-into-block unit 1523 determines that the block of interest is an active block if any one of the pixels inside the block of interest is a peak pixel. The density correction unit 1524 then counts the number of active blocks inside the 5-block-by-5-block area centered at the block of interest, and determines that the block of interest is a screen-dot block if the count is more than a predetermined number. At the end, the expansion unit 1525 performs a 3-block-by-3-block expansion process, so that the block of interest is regarded as a screen-dot area if any one of the 3-×-3 neighboring blocks is a screen dot block.

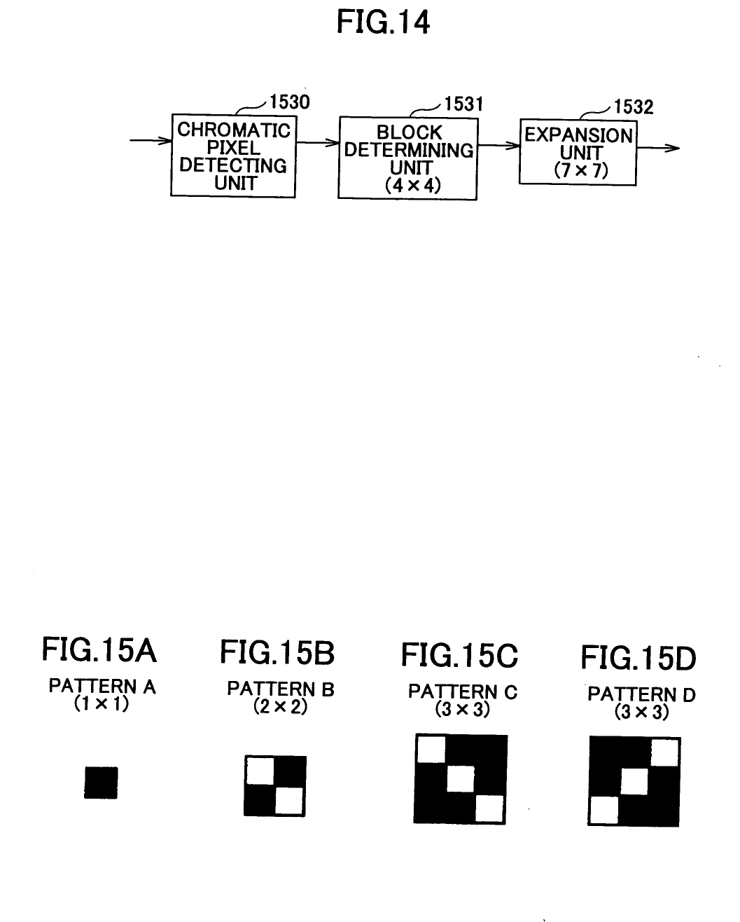

FIG. 14 is a block diagram showing the color check unit 153. The color check unit 153 includes a chromatic pixel detecting unit 1530 for detecting a chromatic pixel if certain conditions are satisfied, a block determining unit 1531 for determining an active block if certain conditions are satisfied, and an expansion unit 1532 for performing a 7-block-by-7-block expansion process.

The chromatic pixel detecting unit 1530 detects a given pixel as a chromatic pixel if the given pixel satisfies Max(|R−G|, |G−B|, |B−R|)>th3 (th3: a predetermined threshold value). Thereafter, with respect to each 4-pixel-by-4-pixel block, the block determining unit 1531 determines that the block of interest is an active block if any one of the pixels inside the block of interest is a chromatic pixel. At the end, the expansion unit 1532 performs an expansion process using a 7-block-by-7-block area. If any one of the blocks is an active block, the block of interest is assigned as a chromatic area. This is only an example of a color check. If a process of removing erroneous decisions through counting operations or the like is performed as in the screen-dot determination, a more reliable check can be achieved.

The patterning unit 16 generates a 1-bit attribute pattern image based on the 2-bit attribute information indicative of black letters, color letters, and screen dots as determined by the attribute determining unit 15. Patterns as shown in FIGS. 15A through 15D are used. A pattern A is used for the black letter attribute, a pattern B used for the color letter attribute, and a pattern C used for the screen-dot attribute. A criteria as to which pattern is used with respect to which attribute is given is as follows.

Since in the case of black letters, high-resolution attribute information is preserved, the pattern having the highest density, i.e., the pattern having the smallest unit-pattern size, is employed. In the case of attribute information such as the screen-dot attribute that does not require high-resolution determination results in a comparative sense, a pattern having a large unit-pattern size such as the pattern C may be assigned.

When the pattern C is assigned to the screen-dot attribute, a pattern D is not assigned to any other attributes. It is conceivable that the functions to rotate and/or mirror an image and its attribute information are available prior to the transmission to the exterior, or are available at the exterior destination. In such case, the pattern C becomes identical to the pattern D, and the pattern D becomes identical to the pattern C by 90-degree or 270-degree rotation or by right-and-left reversal through mirroring. Namely, the correspondences between the attribute information and the patterns end up being swapped, so that pattern selections had better be made by taking into account such rotation and mirroring.

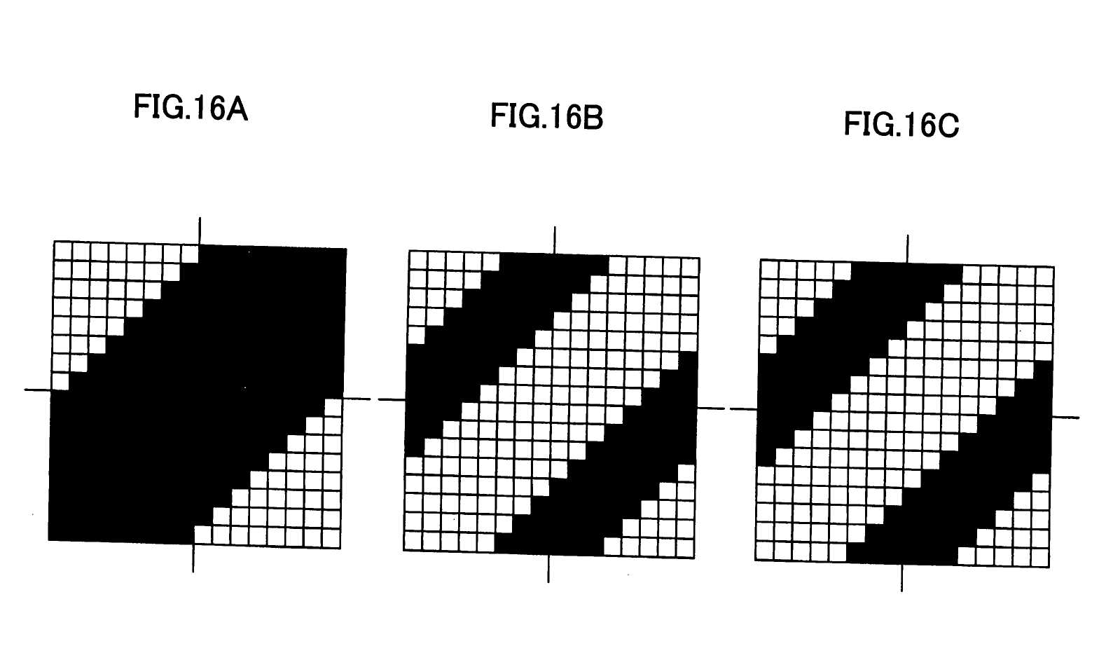

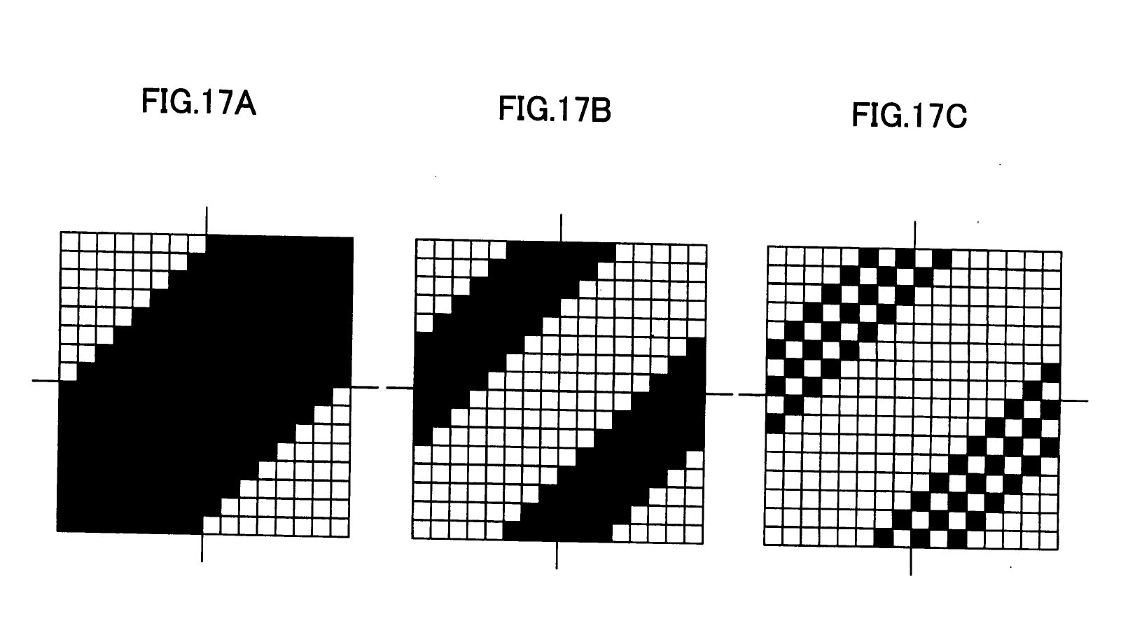

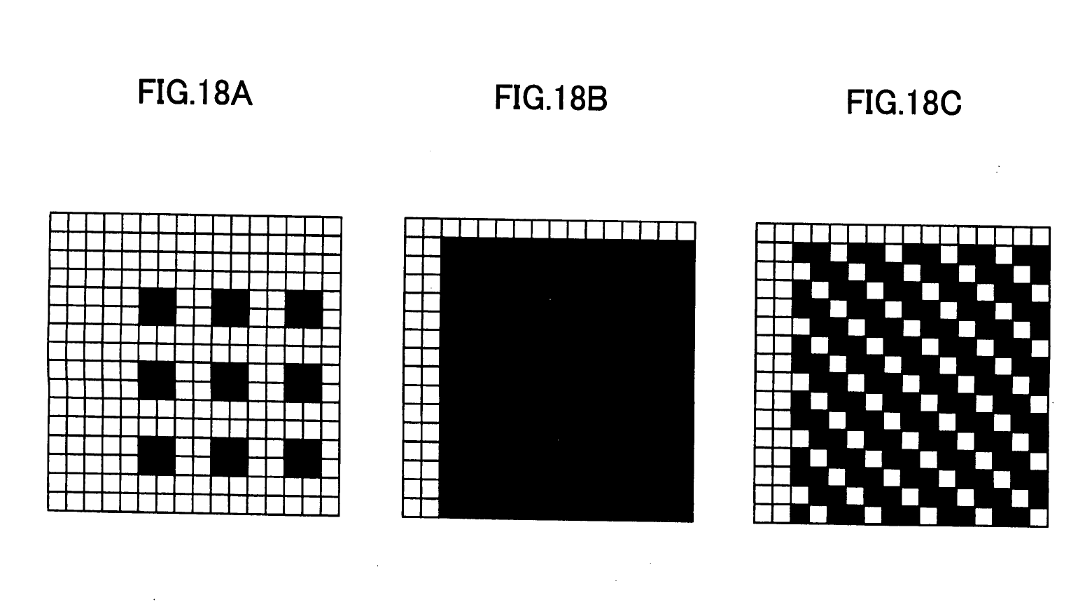

FIGS. 16A through 16C are illustrative drawings showing a portion of a black letter image, the results of attribute determination, and the patterned results of attribute determination, respectively. FIGS. 17A through 17C are illustrative drawings showing a portion of a color letter image, the results of attribute determination, and the patterned results of attribute determination, respectively. FIGS. 18A through 18C are illustrative drawings showing a portion of a screen dot image, the results of attribute determination, and the patterned results of attribute determination, respectively. In the case of the black letter attribute, the attribute pattern image is generated as the attribute information as it is. In the case of the color letter attribute, the attribute pattern image is generated by patterning the attribute information with a checkerboard pattern. In the case of the screen dot attribute, the attribute pattern image is generated by patterning the attribute information with the pattern having diagonally aligned black patches and white patches as shown in FIG. 18C. In the case of the color letter attribute, for example, a specific method of patterning attribute information is to place a white pixel “0” at the pixel positions where the row number plus the column number is an even number and to place a black pixel “1” at the pixel positions where the row number plus the column number is an odd number. In this manner, the placement of black and white is dependent on the pixel positions. In the case of the screen dot attribute, the placement of black and white is also dependent on the pixel positions.

As described above, the present embodiment transmits the compressed image and the 1-bit attribute pattern image to an external apparatus, thereby making it possible to transmit 2 bits worth of attribute information while suppressing the amount of transmitted information. Since the black letter attribute information is practically not patterned, and the color letter attribute information is patterned with the density next highest to the density of the black letter attribute, there is no lowering in the resolution of attribute information with respect to letters (especially with respect to black letters). This ensures high-quality image outputs when images are printed by the printer at the destination.

In the following, a second embodiment will be described. The first embodiment is configured such that a compressed image and an attribute pattern image transformed through patterning are transmitted to an external apparatus. In the second embodiment, further provision is made such as to check whether the external apparatus is capable of analyzing an attribute pattern image when a compressed image and the attribute pattern image are transmitted to the external apparatus. A further check is made to determine whether the apparatus capable of such analysis uses the same corresponding relationships between attributes and patterns as those used at the transmission end. The results of these checks are acquired as transmission destination information in advance. Based on the transmission destination information, the attribute information may be converted for transmission such as to conform to what is suitable to the transmission destination.

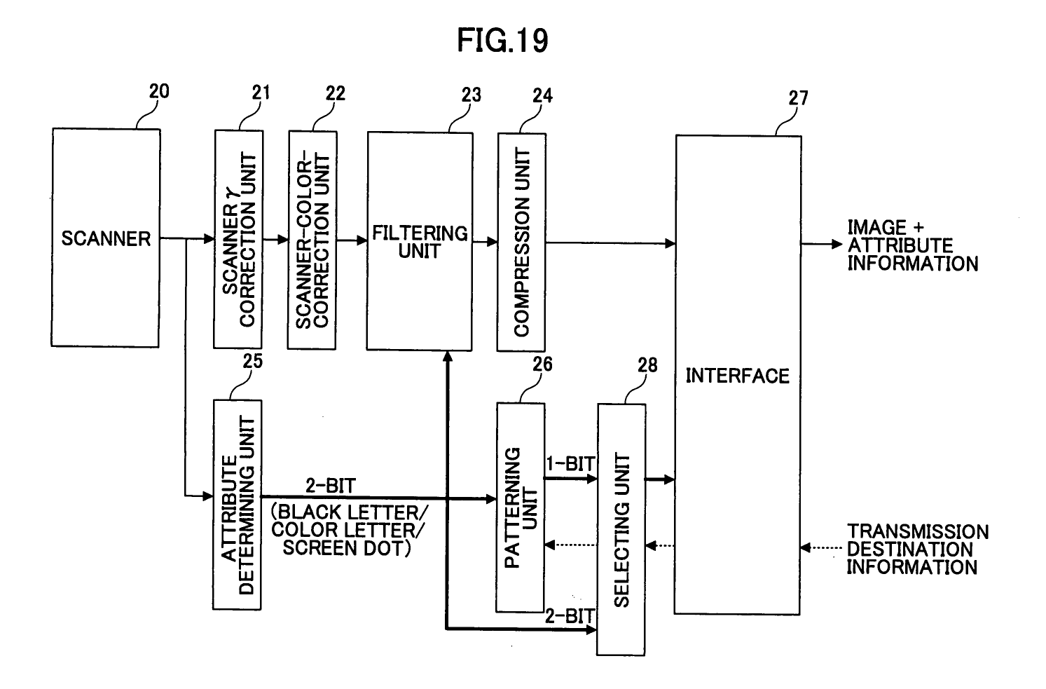

FIG. 19 is a block diagram showing the image processing apparatus according to the present embodiment. As described above, the second embodiment has an additional configuration added to the first embodiment. In the following, a description will be given of only the added configuration, and a description of the duplicate portions will be omitted. The image processing apparatus of FIG. 19 includes a scanner 20 for scanning a document image, a scanner γ correction unit 21 for performing various image processing operations, a scanner color correction unit 22, a filtering unit 23, a compression unit 24 for compressing the filtered image, an attribute determining unit 25 for determining the attributes of the scanned input image, a patterning unit 26 for converting the attribute information into an attribute pattern image, an interface 27 for transmitting the image and the attribute information to an external apparatus, and a selecting unit 28.

The selecting unit 28 refers to the transmission destination information acquired through the interface 27, and decides based thereon whether to transmit the 2-bit attribute information that is not patterned or to transmit the 1-bit attribute pattern image that is patterned. If the correspondence relationships between attributes and patterns are different between the transmission side and the reception side, the differences are reflected in the patterning unit 26 to generate and transmit an attribute pattern image that is analyzable at the reception side.

As described above, the second embodiment can transmit suitable attribute information that reflect information about the reception side in addition to having the same advantages as those of the first embodiment.

In the following, a third embodiment will be described. The third embodiment is directed to a copying process that scans an image by use of the scanner, applies various image processing operations, and outputs the image to the printer.

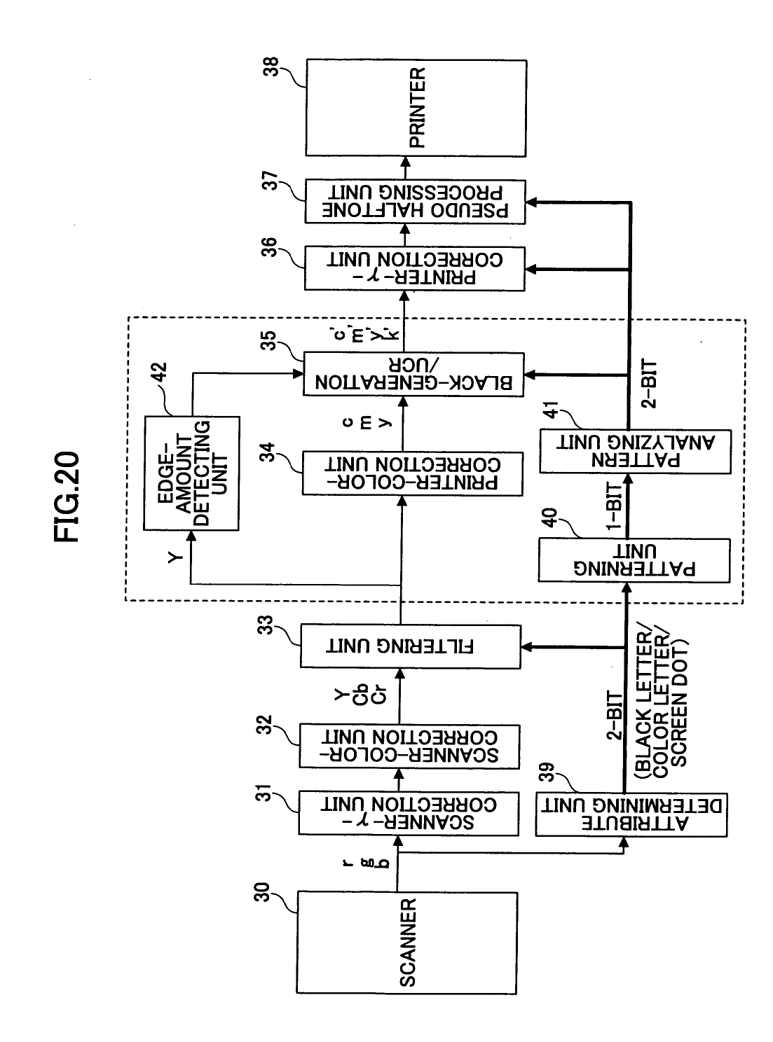

FIG. 20 is a block diagram showing the image processing apparatus according to the present embodiment. The image processing apparatus includes a scanner 30, a scanner-γ-correction unit 31, a scanner-color-correction unit 32, a filtering unit 33, a printer-color-correction unit 34 for converting a filtered image into CMY, a black-generation/UCR 35 for performing conversion into CMYK, a printer-γ-correction unit 36 for performing γ correction by use of a one-dimensional LUT, a pseudo halftone processing unit 37 for performing halftone processing by switching in response to attribute information, a printer 38 for outputting a printout, an attribute determining unit 39, a patterning unit 40, a pattern analyzing unit 41 for analyzing an attribute pattern image to restore the 2-bit attribute information prior to patterning, and an edge-amount detecting unit 42 for detecting the amount of an edge. The image processing that is performed along the path from the scanner 30 to the filtering unit 33 and along the path from the attribute determining unit 39 to the patterning unit 40 is the same as that of the first embodiment, and a description thereof will be omitted.

In the present embodiment, the patterned attribute information is used in an image processing block that is situated nearer to the end of the processing path, so that the pattern analyzing unit 41 analyzes, immediately before the attribute information is used, the attribute pattern image to restore the 2-bit attribute information prior to patterning. The printer-color-correction unit 34 converts the filtered image into CMY, and the black-generation/UCR 35 converts CMY into CMYK. CMYK are the signals corresponding to the colors of the inks used for printer outputs. The black-generation/UCR 35 increases the amount of generated black and the amount of removed under colors as black letters or edge amount increase, and decreases the amount of generated black and the amount of removed under colors as black letters or edge amount decrease, in response to the attribute information and the amount of edge detected by the edge-amount detecting unit 42 from the luminance signal Y. Not only the attribute information but also the edge amount is used, thereby making it possible to reproduce black letters on screen dots with a high amount of black. The printer-γ-correction unit 36 performs γ-correction by use of a one-dimensional LUT. Four LUTs may be provided for use for black letters, for color letters, for screen dots, and for other areas, and may be switched according to the attribute information. The pseudo halftone processing unit 37 applies halftone processing suitable for individual areas by switching between the large number of lines for letters (black letters or color letters) and the small number of lines for other areas, for example. The results are output to the printer.

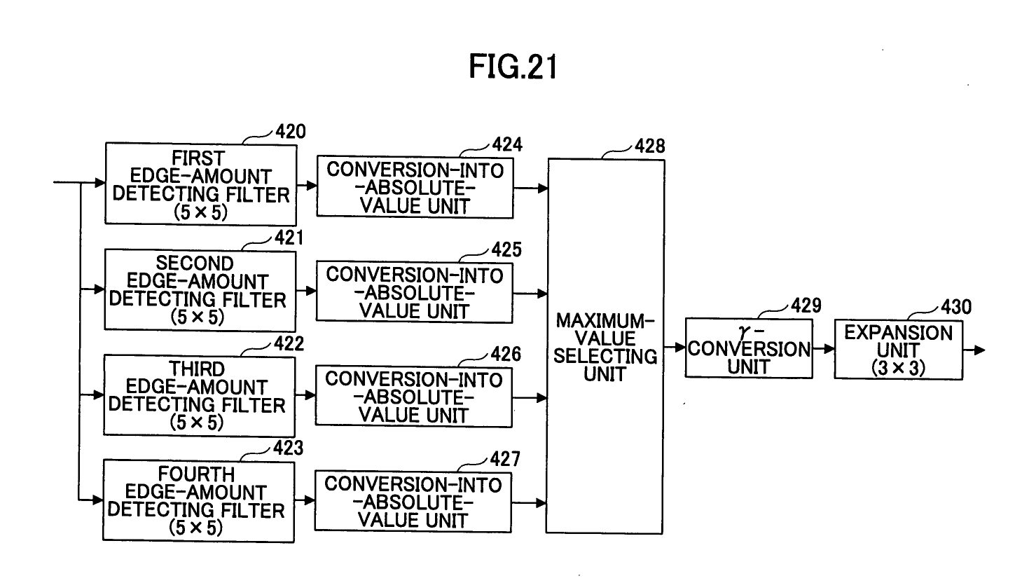

FIG. 21 is a block diagram showing the edge-amount detecting unit 42. The edge-amount detecting unit 42 includes a first edge-amount detecting filter (5×5) 420, a second edge-amount detecting filter (5×5) 421, a third edge-amount detecting filter (5×5) 422, and a fourth edge-amount detecting filter (5×5) 423, each of which performs filtering by use of a corresponding filter, and further includes conversion-into-absolute-value units 424 through 427 for converting the results of the filtering process into absolute values, a maximum-value selecting unit 428 for selecting the largest of the four, a γ-conversion unit 429 for performing correction by use of a one-dimensional LUT, and an expansion unit 430 for performing a predetermined expansion process.

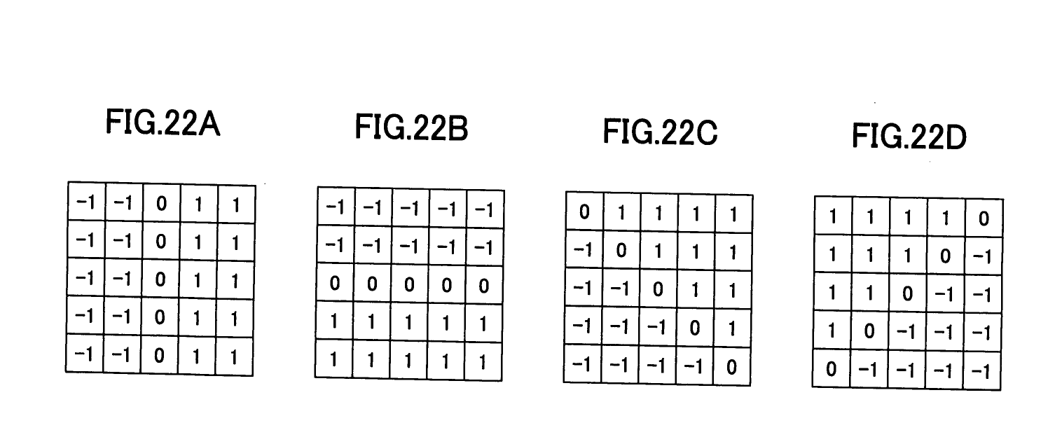

The first edge-amount detecting filter 420 performs filtering by use of the filter as shown in FIG. 22A, the second edge-amount detecting filter 421 by use of the filter as shown in FIG. 22B, the third edge-amount detecting filter 422 by use of the filter as shown in FIG. 22C, and the fourth edge-amount detecting filter 423 by use of the filter as shown in FIG. 22D. The results of the filtering processes are converted into absolute values by the conversion-into-absolute-value units 424 through 427, respectively, followed by using the maximum-value selecting unit 428 to select the largest of the four. Following this, the γ-conversion unit 429 performs corrections such as converting values under a certain level into zero by use of a one-dimensional LUT, and, then, the expansion unit 430 performs an expansion process by referring to 3×3 pixels centered at the pixel of interest.

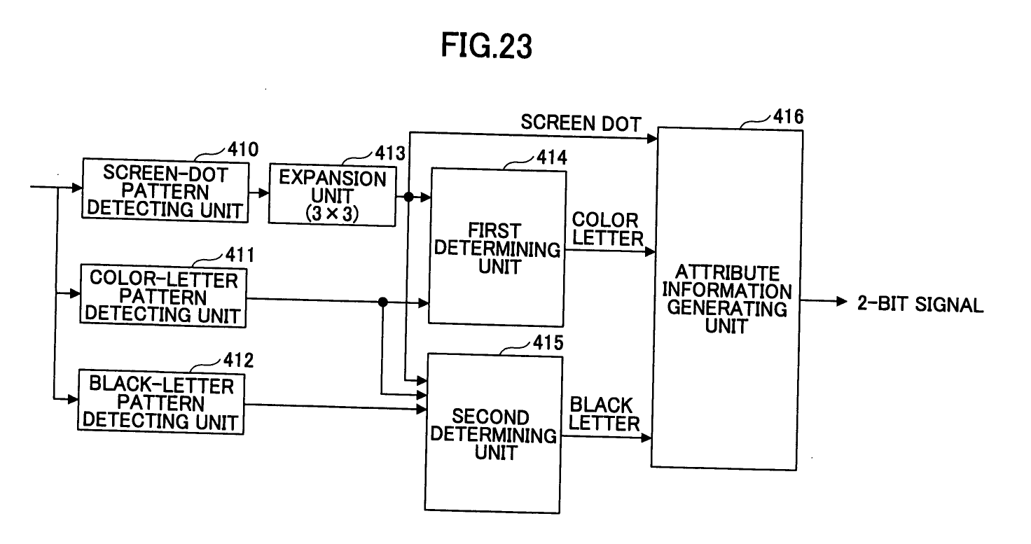

FIG. 23 is a block diagram showing the pattern analyzing unit 41. The pattern analyzing unit 41 includes a screen-dot pattern detecting unit 410 for matching screen dots with predetermined patterns to output the results of matching, a color-letter pattern detecting unit 411 for performing similar matching with respect to color letters to output the results of the matching, a black-letter pattern detecting unit 412 for performing similar matching with respect to black letters to output the results of the matching, an expansion unit 413 for finding screen dots if certain conditions are satisfied, a first determining unit 414 for determining color letters if certain conditions are satisfied, a second determining unit 415 for determining black letters if certain conditions are satisfied, and an attribute information generating unit 416 for restoring 2-bit signals prior to patterning.

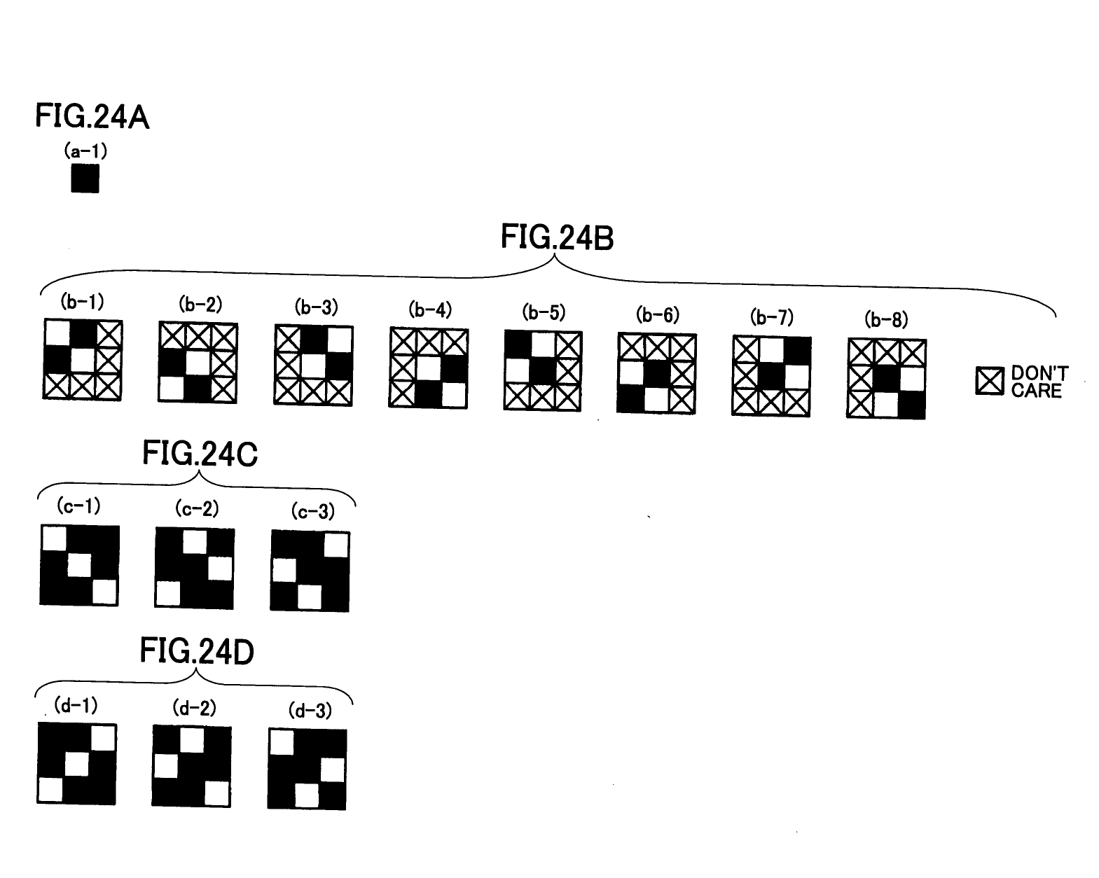

As a general rule, the sizes of the patterns used in the patterning unit 40 (as shown in FIGS. 15A through 15C) are referred, and the black and white patterns thereof are then identified, thereby restoring the 2-bit attribute information prior to the patterning. The screen-dot pattern detecting unit 410 refers to 3×3 pixels centered at the pixel of interest, producing an output that is “1” if the 3×3 pixels match any one of the patterns c-1, c-2, and c-3 of FIG. 24C, and producing an output that is “0” if the 3×3 pixels do not match any one of these patterns. The expansion unit 413 refers to the 3×3 pixels of matching results, and determines that the attribute information of the pixel of interest is the screen dot if any one of the 3×3 pixels is “1”. The color-letter pattern detecting unit 411 performs pattern matching by use of 8 patterns b-1 through b-8 shown in FIG. 24B, thereby producing an output that is “1” if there is a match, and producing an output that is “0” if there is no match. Based on the screen-dot attribute information as obtained above and the results of the color-letter pattern detecting unit 411, the first determining unit 414 determines that the attribute information of the pixel of interest is the color letter if the pixel of interest is not the screen-dot and if the result of the color-letter pattern detection indicates “1” (match). The black-letter pattern detecting unit 412 performs pattern matching by use of a pattern a-1 shown in FIG. 24A, thereby producing an output that is “1” if there is a match, and producing an output that is “0” if there is no match. Based on the screen-dot attribute information, the color-letter attribute information, and the results of the black-letter pattern detecting unit 412, the second determining unit 415 determines that the attribute information of the pixel of interest is the black letter if the pixel of interest is neither the screen-dot nor the color letter and if the result of the black-letter pattern detection indicates “1” (match). The attribute information generating unit 416 performs conversion into 2-bit signals corresponding to the attribute information as shown in FIG. 6, thereby restoring the attribute information prior to patterning.

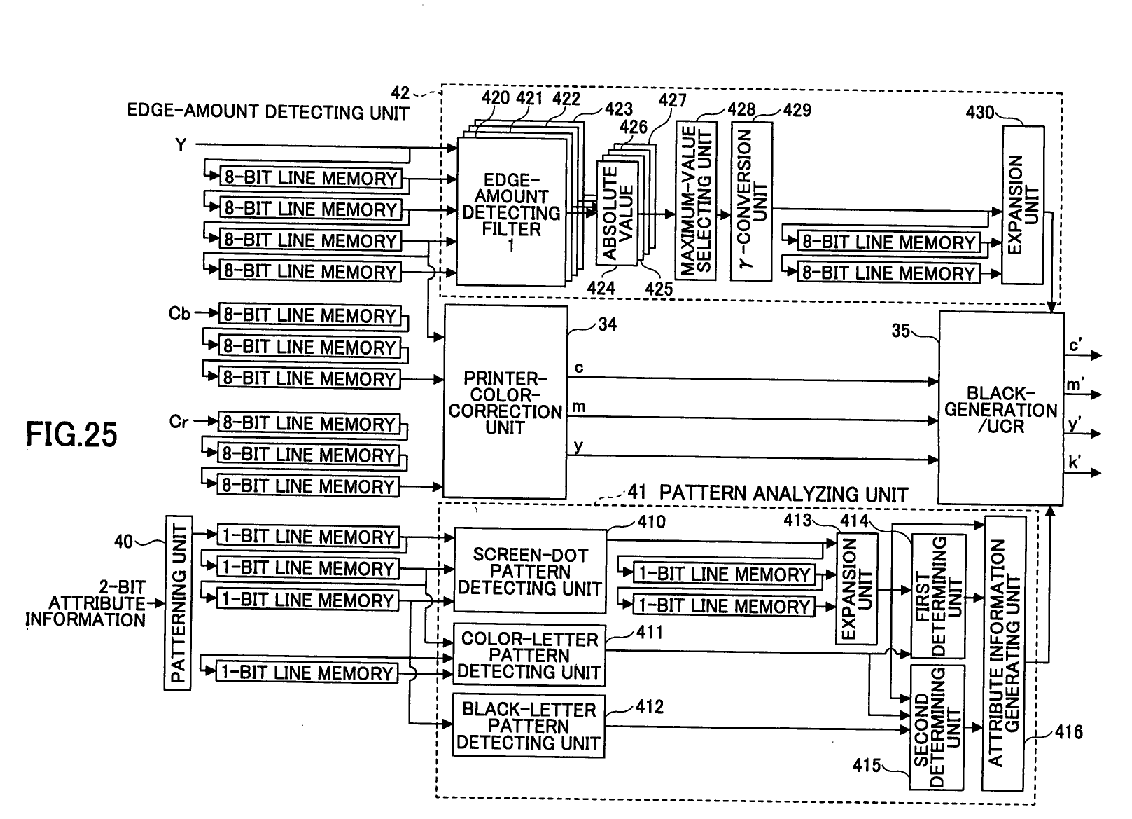

FIG. 25 is a drawing showing line memories that are necessary for the processing blocks enclosed in dotted lines in FIG. 20 that includes the pattern analyzing unit 41 and the edge-amount detecting unit 42. In the following, details will be described.

The edge-amount detecting unit 42 requires four 8-bit line memories for the edge-amount detecting filters to refer to 5×5 lines and two 8-bit lines memories for the expansion unit 430 to refer to 3×3 pixels, a total of which is six 8-bit line memories.

Since a delay corresponding to three lines is created by the edge-amount detecting unit 42, the signals Cb and Cr that are not used for the calculation of edge amount also need to be delayed in order to ensure synchronization. Each signal requires three 8-bit line memories, so that six 8-bit line memories are required in total.

On the other hand, the patterning unit 40 does not require a line memory since it does not refer to surrounding pixels. The pattern analyzing unit 41 requires three 1-bit line memories for the screen-dot pattern detecting unit 410 to refer to 3×3 pixels and two 1-bit line memories for the expansion unit 413 to refer to 3×3 pixels in the case of the recovery of the screen-dot attribute information that has the largest reference area. Further, in order to ensure synchronization with the edge-amount detecting unit 42, an additional 1-bit line memory for the delay purpose is provided prior to the pattern detection process, so that six 1-bit line memories are used in total.

In the following, a case in which the 2-bit attribute information is kept without patterning and pattern analysis will be examined. In such a case, three delay-purpose line memories, i.e., three 2-bit line memories, are necessary as in the case of Cb and Cr, rather than the six 1-bit line memories. This is equivalent to six 1-bit line memories. It can thus be understood that there is no increase in line memories due to the patterning and pattern analysis.

For the sake of facilitating the understanding, the above description was given with respect to the case in which the attribute information prior to patterning is 2-bit information. By taking 4-bit attribute information as an example, a case in which patterning into a 1-bit pattern and pattern analysis are performed will be compared with a case in which no such patterning and pattern analysis is performed. When patterning is performed (using patterns with their unit size no larger than 3×3 pixels), six 1-bit line memories are required in the same manner as described above. When patterning is not performed, three 4-bit line memories are required, which are equivalent to twelve 1-bit line memories. In this manner, the larger the number of bits of the attribute information prior to patterning, the greater the reduction in the line memories through patterning is.

As described above, the third embodiment can reduce the amount of line memories when an increased amount of attribute information is necessary for a copying process. Since the black letter attribute information is practically not patterned, and the color letter attribute information is patterned with the density next highest to the density of the black letter attribute, there is no lowering in the resolution of attribute information with respect to letters (especially with respect to black letters). This ensures high-quality copy image outputs.

In the following, a fourth embodiment will be described. The fourth embodiment is directed to a copying process in which a compressed image and a patterned attribute information image are kept in storage, and are then rotated or subjected to right-and-left reversal according to a user request, followed by being output to the printer.

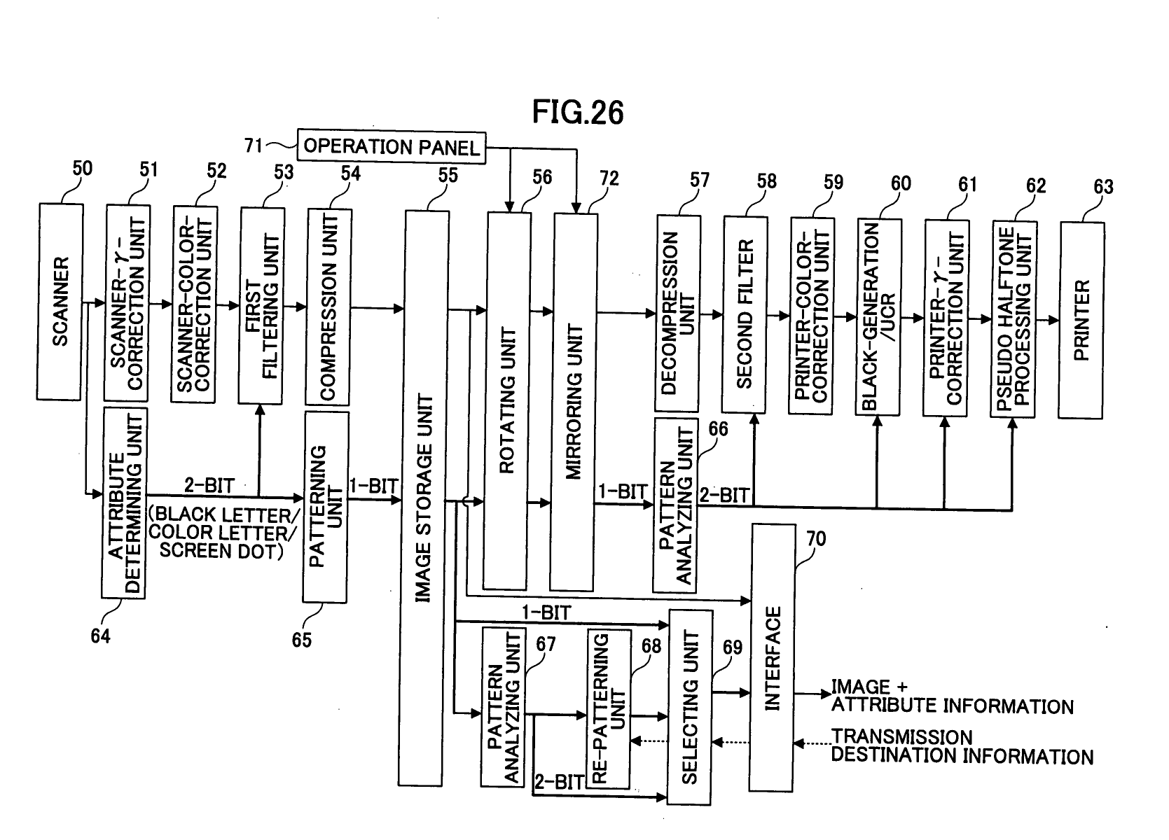

FIG. 26 is a block diagram showing the image processing apparatus according to the present embodiment. The image processing apparatus includes a scanner 50, a scanner-γ-correction unit 51, a scanner-color-correction unit 52, a first filtering unit 53, a compression unit 54, an image storage unit 55 for temporarily storing a compressed image and patterned attribute information, a rotating unit 56 for performing rotation according to user request, a decompression unit 57 for performing decompression, a second filter 58, a printer-color-correction unit 59, a black-generation/UCR 60, a printer-γ-correction unit 61, a pseudo halftone processing unit 62, a printer 63, an attribute determining unit 64, a patterning unit 65, a pattern analyzing unit 66, a pattern analyzing unit 67, a re-patterning unit 68, a selecting unit 69, an interface 70, an operation panel 71 for allowing a user to select rotation, mirroring, and the like, and a mirroring unit 72 for performing left-right reversal according to user request. The image processing that is performed along the path from the scanner 50 to the compression unit 54 and along the path from the attribute determining unit 64 to the patterning unit 65 is the same as that of the first embodiment, and a description thereof will be omitted.

Halfway through the copying process, the image storage unit 55 temporarily stores the compressed image and patterned attribute information. According to a user request entered on the operation panel 71, the rotating unit 56 rotates the image and patterned attribute information retrieved from the image storage unit 55 by 0 degree, 90 degrees, 180 degrees, or 270 degrees. By the same token, the mirroring unit 72 performs left-right reversal of the image according to a user request. The pattern analyzing unit 66 analyzes the stored attribute pattern image to restore the 2-bit attribute information, which will be used for image processing at a subsequent stage such as black-generation/UCR.

The pattern analyzing unit 66 is configured to properly analyze the patterns even if the images are rotated by the rotating unit 56 or subjected to left-right reversal by the mirroring unit 72, in addition to performing the analysis of the pattern analyzing unit 41 described in the third embodiment. For example, the screen-dot pattern detecting unit 410 checks whether a matching pattern exists by using 6 patterns that includes not only the patterns c-1 through c-3 of FIG. 24C but also patterns d-1 through d-3 of FIG. 24D, which correspond to the pattern of FIG. 15D (which is rotated by 90 degrees with respect to the pattern of FIG. 15C).

The image and attribute pattern image stored in the image storage unit 55 may as well be transmitted to an external apparatus via the interface 70. As in the second embodiment, provision may be made such that the transmission destination information is acquired, and such that the pattern analyzing unit 67 restores the 2-bit attribute information for transmission. Further, the re-patterning unit 68 may perform re-patterning to create a pattern analyzable by the external apparatus, which is then selected by the selecting unit 69 for transmission

According to the present embodiment, the 1-bit attribute pattern image, rather than the 2-bit attribute information, is stored in the apparatus that is provided with the function for temporal image storage halfway through a copying process. This makes it possible to store 2 bits worth of attribute information while suppressing the amount of stored information. Since the black letter attribute information is practically not patterned, and the color letter attribute information is patterned with the density next highest to the density of the black letter attribute, there is no lowering in the resolution of attribute information with respect to letters (especially with respect to black letters). This ensures high-quality copy image outputs.

In the following, a fifth embodiment will be described. The fifth embodiment is directed to a printing process that outputs to the printer according to a printer output request sent from an application. In the printing process, an expansion to RGB bitmap images may be performed, and an attribute map image may be generated based on embodiment information, with the bitmap images and the attribute map image being stored in an image storage unit. This provision makes it possible to treat the stored images in the same manner as the stored images of a copying process shown in FIG. 26 are treated, thereby providing for the sharing of procedures performed at the subsequent stages.

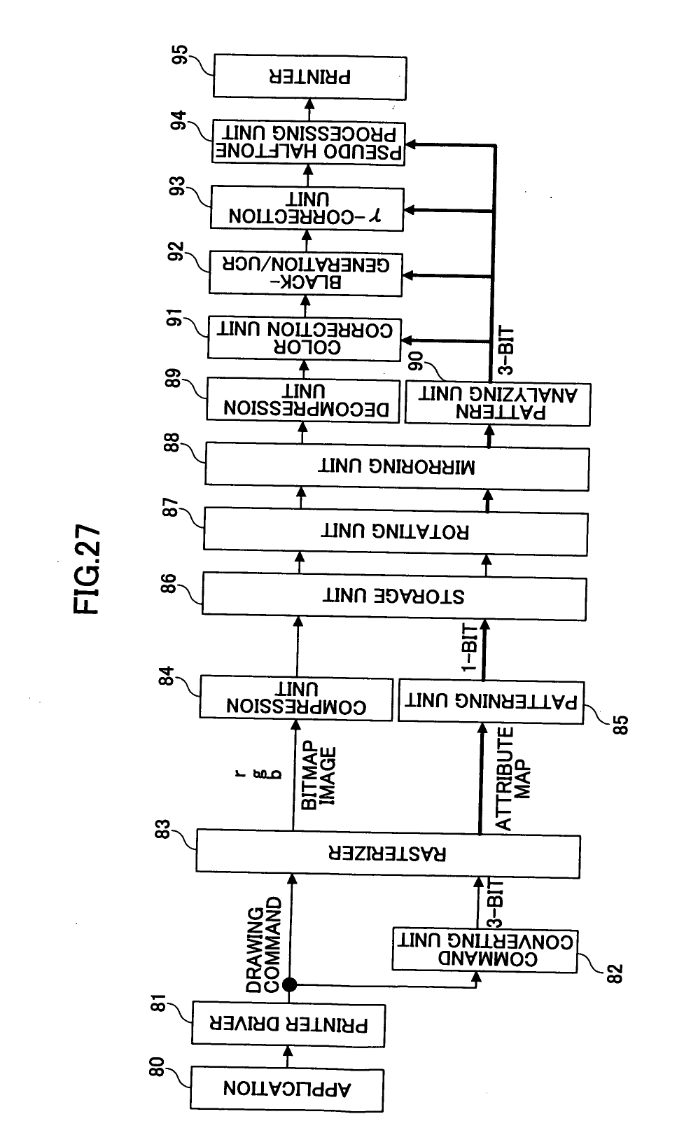

FIG. 27 is a block diagram showing the image processing apparatus according to the present embodiment. The image processing apparatus includes an application 80 for sending a printer output request, a printer driver 81 for converting the printer output request into a drawing command, a command converting unit 82 for converting the drawing command into embodiment information, a rasterizer 83 for generating bitmap images and an attribute map, a compression unit 84 for compressing the bitmap images, a patterning unit 85 for patterning the attribute map image, an image storage unit 86 for storing the compressed bitmap images and the patterned attribute information, a rotating unit 87, a mirroring unit 88, a decompression unit 89, a pattern analyzing unit 90, a color correction unit 91, a black-generation/UCR 92, a γ-correction unit 93, a pseudo halftone processing unit 94, and a printer 95. The processing that is performed along the path from the rotating unit 87 to the printer 95 is the same as that of the fourth embodiment, and a description thereof will be omitted.

A printer output request sent from the application 80 is converted into a drawing command by the printer driver 81. The rasterizer 83 generates bitmap images in response to the drawing command, and, at the same time, the command converting unit 82 reads object information from the drawing command to create an attribute map image. The compression unit 84 then compresses the bitmap images. The patterning unit 85 patterns the attribute map image. The image storage unit 86 stores the compressed bitmap images and the patterned attribute information.

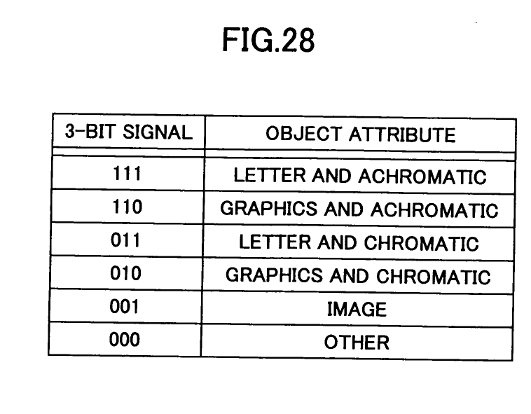

Basically, the attribute map image is comprised of three types of object information (object attributes), i.e., letter, graphic, and image, as shown in FIG. 28. The letter attribute and graphic attribute also have information indicative of either achromatic or chromatic. This provision is made in order for the black-generation/UCR 92 to be able to select either K monochrome reproduction or CMY reproduction for the reproduction of black letters and black lines in response to an instruction from the application 80.

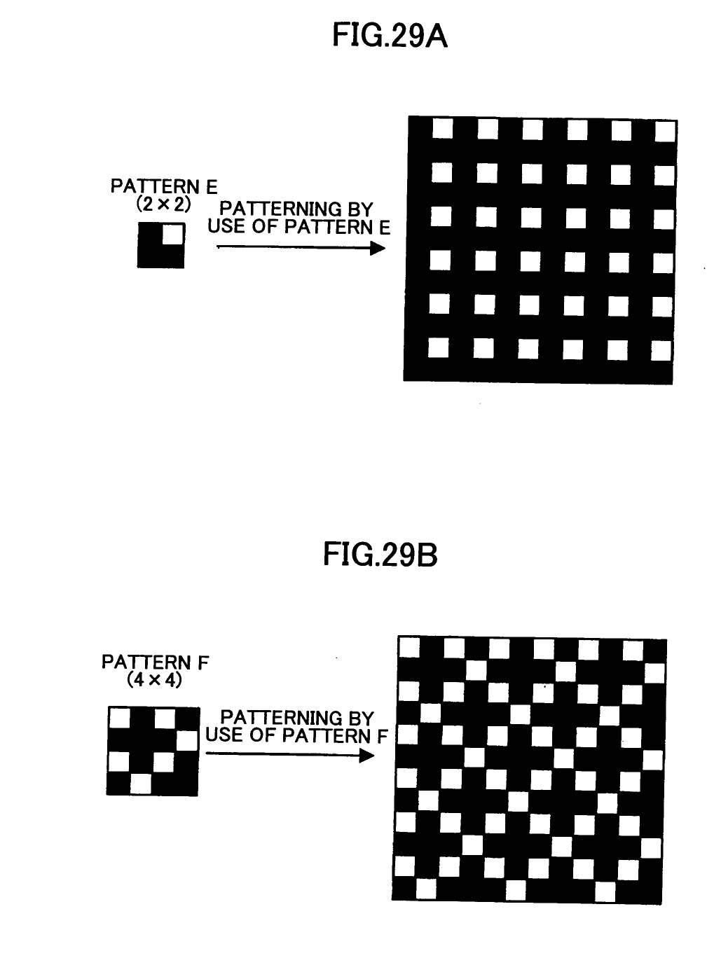

Since the attribute information is 3-bit information, patterning is performed by use of patterns E and F shown in FIGS. 29A and 29B, respectively, in addition to the patterns A through C shown in FIGS. 15A through 15C, respectively. The pattern A is assigned to the achromatic letter attribute, the pattern B to the chromatic letter attribute, the pattern E to the achromatic graphic attribute, the pattern C to the chromatic graphic attribute, and the pattern F to the image attribute. It is preferable to select patterns such that the black letter attribute is assigned with the highest-density pattern, and such that black line drawings are assigned with a relatively high density pattern by taking into account the characteristics of line drawings in graphics.

In this embodiment, patterning converts 3-bit information into 1-bit information. As another example, the present invention is applicable to conversion from 3-bit information into 2-bit information. In such a case, the pattern A may be assigned to the letter attribute, the pattern B to the graphic attribute, and the pattern C to the image attribute. Further, the patterned image may be stored in the upper-order bit of the 2 bits in the case of the chromatic attribute, and may be stored in the lower-order bit of the 2 bits in the case of the achromatic attribute.

According to the present embodiment, the 1-bit or 2-bit attribute pattern image after patterning, rather than the 3-bit attribute information, is stored in the apparatus that is provided with the function for temporal image storage halfway through a printing process. This makes it possible to store 3 bits worth of attribute information while suppressing the amount of stored information. Further, since the patterning is performed with high density, especially with respect to black letter attribute information and black line drawing attribute information, degradation due to the lowering of resolution is not likely to happen, resulting in a printer output image having high image quality.

According to the present invention described above, an image and patterned attribute information are transmitted to an external apparatus, so that transmission is performed without substantially lowering the resolution of the attribute information while reducing the amount of transmitted information. Further, the image and attribute information are transmitted to the external apparatus after the transmission destination information is checked, so that the attribute information can be transmitted in the form suitable to the transmission destination. Further, the image and patterned attribute information are sent to the image processing performed at later stages of a copying process, so that transmission is performed without substantially lowering the resolution of the attribute information while reducing the amount of transmitted information. Further, the image and patterned attribute information are stored in the storage unit provided halfway through a copying process, so that information storage is performed without substantially lowering the resolution of the attribute information while reducing the amount of stored information. A high-density pattern is assigned to letter images, especially to black letters, thereby making it possible to transmit or store letter attribute information with high resolution, which results in the image reproduction having high image quality. Since the patterns to be assigned to the attributes are selected by taking into account rotation and mirroring, the attributes can be restored by performing pattern analysis on the images having experienced rotation and/or mirroring, without a need to be conscious of whether such rotation and/or mirroring have been performed.

Further, the present invention is not limited to these embodiments, but various variations and modifications may be made without departing from the scope of the present invention.

What is claimed is:

1. An image processing apparatus, comprising:
an image acquisition unit to acquire an image;
an attribute determining unit to determine position-dependent attributes of the acquired image acquired by the image acquisition unit; and
a patterning unit to generate an attribute pattern image that represents the position-dependent attributes by respective spatial patterns.

2. The image processing apparatus as claimed in claim 1, further comprising
a transmission unit to transmit the acquired image and the attribute pattern image to an external apparatus via a network.

3. The image forming apparatus as claimed in claim 2, further comprising a check unit to check if the external apparatus is capable of analyzing the attribute pattern image, wherein the transmission unit is operable to transmit the position-dependent attributes in place of the attribute pattern image according to need.

4. The image forming apparatus as claimed in claim 2, further comprising a check unit to check attribute patterns that the external apparatus is capable of analyzing, wherein the attribute pattern image is converted, for transmission, into an attribute pattern image comprising of the attribute patterns that the external apparatus is capable of analyzing according to need.

5. The image processing apparatus as claimed in claim 1, further comprising:
an image processing unit; and
a transmission unit to transmit the acquired image and the attribute pattern image to the image processing unit.

6. The image processing apparatus as claimed in claim 1, further comprising:
a storage unit to store the acquired image and the attribute pattern image; and
an image processing unit to retrieve the acquired image and the attribute pattern image from the storage unit to perform image processing with respect to the acquired image according to the position-dependent attributes.

7. The image forming apparatus as claimed in claim 1, wherein the position-dependent attributes include a letter attribute, and the patterning unit is operable to represent the letter attribute by a spatial pattern that is denser than a spatial pattern used to represent any other attribute.

8. The image forming apparatus as claimed in claim 1, wherein the position-dependent attributes include a black-letter attribute, and the patterning unit is operable to represent the black-letter attribute by a spatial pattern that is denser than a spatial pattern used to represent any other attribute.

9. The image forming apparatus as claimed in claim 1, wherein the position-dependent attributes include a color-letter attribute, and the patterning unit is operable to represent the color-letter attribute by a spatial pattern that is denser than a spatial pattern used to represent any other attribute, except for a black-letter attribute.

10. The image forming apparatus as claimed in claim 1, further comprising a rotation unit to rotate the acquired image and the attribute pattern image by 90 degrees, 180 degrees, or 270 degrees, wherein each of the spatial patterns is configured such as not to match any other one of the spatial patterns after rotation by any degrees.

11. The image forming apparatus as claimed in claim 1, further comprising a mirroring unit to perform left-right reversal with respect to the acquired image and the attribute pattern image, wherein each of the spatial patterns is configured such as not to match any other one of the spatial patterns after mirroring.

12. A method of processing an image, comprising:
acquiring an image;
determining position-dependent attributes of the acquired image; and
generating an attribute pattern image that represents the position-dependent attributes by respective spatial patterns.

13. A computer-readable recording medium having a program embodied therein for causing a computer to process an image by:
acquiring an image;
determining position-dependent attributes of the acquired image; and
generating an attribute pattern image that represents the position-dependent attributes by respective spatial patterns.
